(19) United States
(12) Patent Application Publication
(10) Pub. No.: US 2023/0400109 A1
(43) Pub. Date: Dec. 14, 2023

(54) VALVE AND SYSTEM

(71) Applicant: CARLISLE FLUID TECHNOLOGIES, LLC, Scottsdale, AZ (US)

(72) Inventors: Alan Smith, West Moors (GB); Christopher Strong, Frederick, CO (US); David Crowther, Bloomfield Hills, MI (US)

(21) Appl. No.: 18/037,535

(22) PCT Filed: Nov. 19, 2021
(86) PCT No.: PCT/US2021/060220

§ 371 Date: May 17, 2023

Related U.S. Application Data
(60) Provisional application No. 63/115,917, filed on Nov. 19, 2020.

(51) Int. Cl. F16K 11/087; B05B 12/14

(52) U.S. Cl. CPC F16K 11/0873; B05B 12/1481

(57) ABSTRACT

A diverter valve can include an inlet; a main line outlet; a flow control outlet; and a bypass member, wherein the bypass member comprises a passage extending through an axis of the bypass member and a plurality of notches. In some embodiments, the diverter valve can provide that the bypass member is configured to be switchable between an open position that allows a flow from the inlet to the main line outlet and a flow control position that allows flow from the inlet to the flow control outlet.

### BACKGROUND

A valve can include an inlet, a main line outlet; a flow control outlet, and a bypass member, wherein the bypass member comprises a passage extending through an axis of the bypass member and a plurality of notches.

### SUMMARY

A diverter valve can include an inlet; a main line outlet; a flow control outlet; and a bypass member, wherein the bypass member comprises a passage extending through an axis of the bypass member and a plurality of notches. In some embodiments, the diverter valve can provide that the bypass member is configured to be switchable between an open position that allows a flow from the inlet to the main line outlet and a flow control position that allows flow from the inlet to the flow control outlet.

### BRIEF DESCRIPTION OF THE FIGURES

FIG. 1 is an example, non limiting cutaway view of the diverter valve of the embodiments described herein.

FIG. 2 is an example, non limiting side view of the diverter valve of the embodiments described herein.

FIG. 3 is an example, non limiting cutaway view of the pig of the embodiments described herein.

FIG. 4 is an example, non limiting view of a ball type bypass member of the embodiments described herein.

FIG. 5 is an example, non limiting top cutaway view of the diverter valve of the embodiments described herein.

FIG. 6 is an example, non limiting top cutaway view of the diverter valve of the embodiments described herein.

FIG. 7 is an example, non limiting view of a coating delivery and flow control system of the embodiments described herein.

FIG. 8 is an example, non limiting view of the pig test system of the embodiments described herein.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

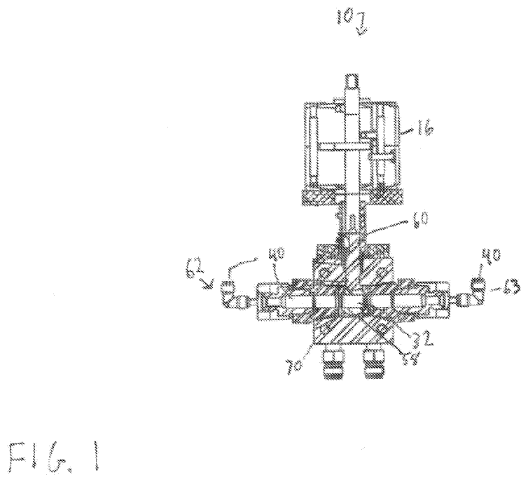

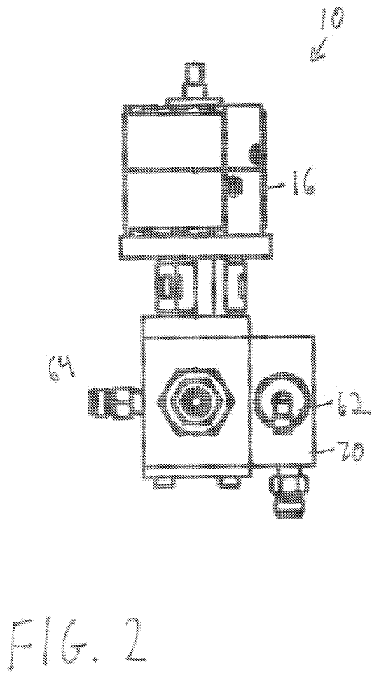

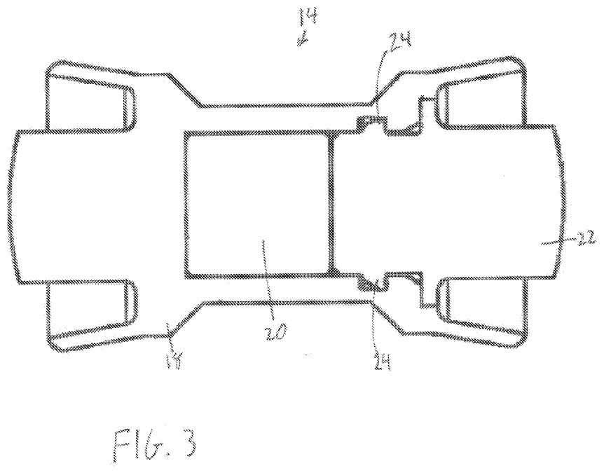

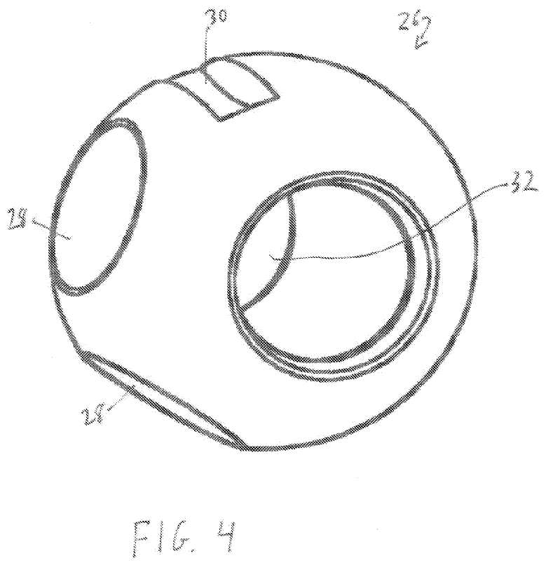

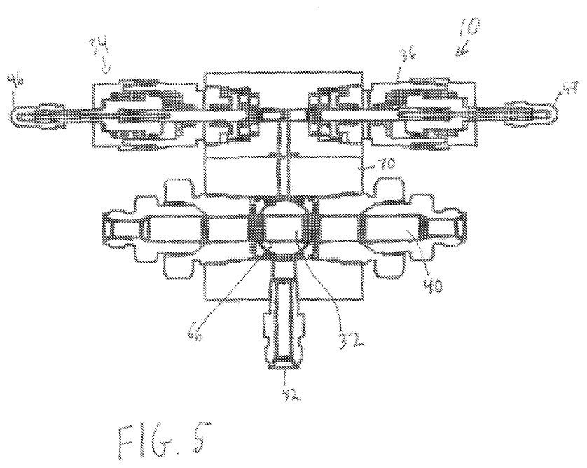

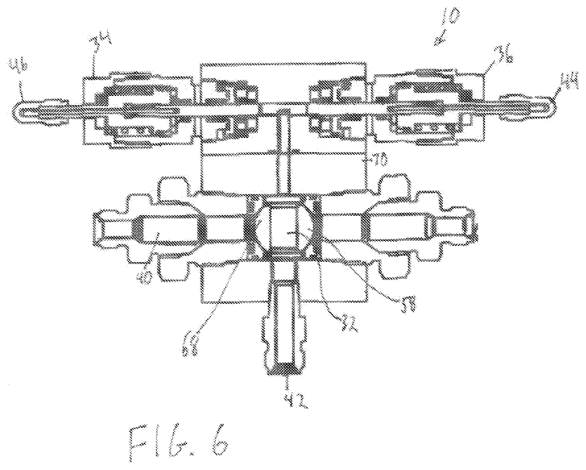

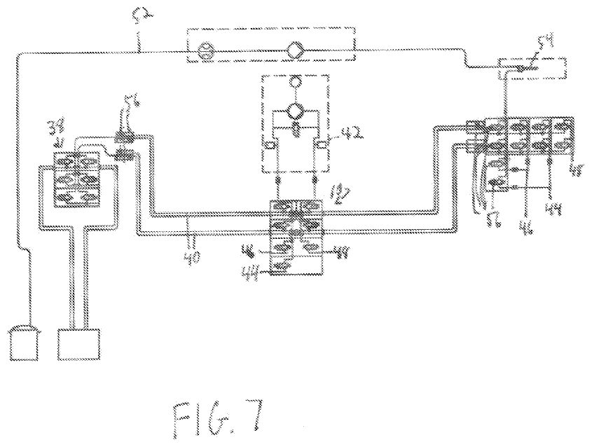

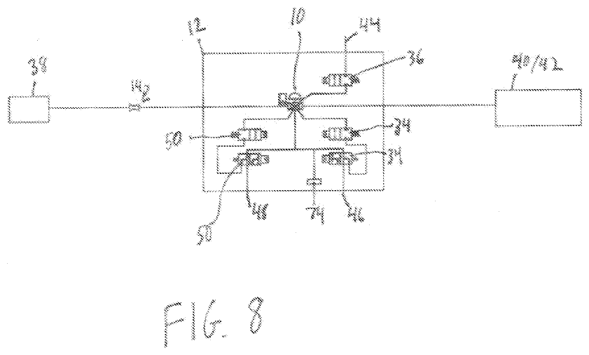

As shown in FIGS. 1-10, disclosed is new ball 26 valve design for piggable systems. It can be a 2-way valve that will be used to test pigs for wear and replace them if necessary. When the valve is open, paint and pigs can flow freely through the valve and into the paint lines 40 or flow-control system. When the valve is closed, a pig 14 can be caught, tested, and replaced. Having a pig test station 12 in a paint line 40 can allow the end user to automatically monitor the pig's life. If a pig 14 is completely worn, the end user can then easily install a new pig. This pig test station 12 can save lost production downtime as well as costly repair work due to failed pigs in piggable paint lines 40. The pig test station 12, as well and the main line 40, can include a solvent line 44, air line 46, and dump line 48.

As used herein, a flow control device 72, which can be used within a flow control line 42, can be a device that measures and controls an exact amount of paint or other coating flow. Automotive and Tier 1 painting systems can have flow control devices 72 installed to supply paint to the applicators 54. When the applicator(s) 54 are not spraying, the paint or coating in the lines can be reclaimed back to the paint headers or to the original paint containers. Current systems use pigs and pigging devices to reclaim this paint. Pigs, however, cannot travel through flow control devices 72.

Further, paint lines 40 and flow control devices 72 must also be cleaned after the reclaim process in preparation for a new paint color or different coating. Time can be saved by cleaning the main paint lines 40 and flow control device 72 independently and simultaneously. Accordingly, valves, such as the diverter valve 10 of the present embodiments, are needed in these systems that can isolate the main paint lines 40 from the flow control device 72. These valves can block flow to the flow control device 72 and allow pigs to travel through them during reclaim and cleaning. These same valves must, when needed, change state and allow paint flow into the flow control device 72, such as by action of a rotary actuator 16 upon the valves through the use of an actuator stem 60 acting upon the bypass member 26.

When a piggable paint line 40 is empty and is ready for a new color to be loaded, the pig 14 can be tested. The pig 14 starts the testing process in the pig 14 catch/launch 56 block located at the main color header 38. The pig 14 can be launched from there with compressed air. The pig test station 12 can be configured for pig 14 catch by rotation of the station center-ball, which can be caused by a rotary actuator attached to the ball. A dump valve 50 can be opened to allow any pressure on the down-stream side of the pig 14 to evacuate the line. When the pig 14 seats against a center ball, the magnetic pig 14 position sensor detects the presence of the magnet 20 in the pig 14 and sends a signal to the control unit that the pig 14 is in position and ready for a test.

When ready for a pig 14 test, the rotary actuator rotates counterclockwise 90° until the center ball 26 is in the test position. The pig 14 sensor is configured to continue to show an “in position” signal. An air valve 34 can be opened, allowing compressed air to fill the cavity nd pressurize the lower lips of the pig. A dump valve 50 can remain open during the test to evacuate any pressurized air that escapes around the pig 14 lips into the center chamber of the test station. The pressure sensor can monitor the pressure inside the filled cavity and sends that data to the control unit. The pressure is monitored for a fixed length of time (e.g., 30 seconds). If the pressure decays a certain amount over this time (e.g., a 25% or 2 bar drop), the lips are worn enough such that the pig 14 is not usable and must be replaced. A signal can be indicated at the control unit that the pig 14 must be replaced before using that paint line 40 again. If the pressure does not decay more than a threshold over this time, the pig 14 lips are still in good condition and the pig 14 is sufficient for continued use. A signal can be indicated at the control unit that the pig 14 is good for continued use in that paint line 40. At this point, regardless of the pig 14 status, an air valve 34 is closed, sealing off the compressed air supply. A dump valve 50 is opened, allowing all pressurized air to evacuate to dump.

The valve and system can utilize a pig. The pig 14 can include a magnet 20 configured to interact with magnet 20ic sensors placed throughout the system to indicate the position of the pig 14 within the system. The pig 14 can include a pig main body 18 configured to attach to an end cap 22 via at least one retention barb 24. Glue can further be util to attach the end cap 22 to the pig main body 18. The pig main body 18 and end cap 22 surround the magnet 20.

If the pig 14 needs to be replaced, the control unit can send a signal or signals to enter the pig 14 replace sequence at the test station. An air valve 34 and dump valve 50 can be opened. The pressure on the top lips of the pig 14 push it down until it stops against the pig-replace stem. A dump valve 50 evacuates any pressure that may build up beneath the pig 14 and prevent it from seating against the stem. The pig 14 sensor can send a signal that the pig 14 is not in position. An air valve 34 can be closed and all pressure is evacuated through a dump valve 50. A user can unthread the pig-replace stem. This stem 74 may be magnet 20ized or manufactured from a magnet 20ic material so that the pig 14 remains stuck to it when unthreaded. Based on stem 74 removal, the old pig 14 can be discarded and a new one can be placed into the stem. The stem 74 can be threaded back into the test station. If, for any reason, the pig 14 did not seat on the stem 74 before removal, it can be retrieved with a tool once the stem 74 is removed. Once a new pig 14 is installed, the user can push a button at the control unit that a new pig 14 is installed and ready for use. The dump valve 50 can be closed based on installation.

The air valve 34 and dump valve 50 can be opened based on installation. Compressed air can push the pig 14 back into its seated position inside the center ball. The pig 14 position sensor shows an “in position” signal based on detection of the magnet 20. All valves are closed.

The rotary actuator rotates the center ball 26 back to a pig 14 Catch position. The pig 14 position sensor shows an “in position” signal. Air valves 34 can be open. The compressed air pushes the pig 14 out of the test station and returns it all the way back to the launch/catch block at the main color header 38. A pig 14 sensor in this block can signal that the pig 14 is home, based on detection of the magnet 20 in the pig, and that it is now ready for normal use.

Paint from the main color header 38 launches the pig 14 through the main lines. Sometimes, a small amount of paint is injected in front of the pig 14 to act as lubrication. The pig 14 goes through the test station, without stopping for test, through the main lines, and all the way to a catch block on the robot arm. That color is now ready for spraying.

When a new color is to be loaded in that main line, the old color must first be removed. After that color is removed, the line is flushed with solvent to clean all the old color out of the lines. At this time, the test station is also flushed to clean any old paint out of the center chamber and passageways. If not flushed, paint can also leak by the ball 26 seals after use when the seals start to leak. Flushing will make clean all the areas where paint may exist. The rotary actuator rotates counterclockwise 90° until the center ball 26 is in the test position. The solvent valve 36 opens, as do both dump valves 50. Solvent is sent through the test station for a pre-determined amount of time. After this time, the solvent valve 36 is closed, and both air valves 34 are opened. The air valves 34 are opened for a pre-determined amount of time to clear the solvent from the test station. After this time, all valves are closed. The test station and main line are now ready for normal use.

Disclosed is a new valve design for piggable systems, a 3-way valve that will be used to divert/bypass paint flow from the main paint line 40 to a flow-control device. When the valve is open, pigs, paint, or cleaning materials will travel through the valve and through the paint main line. When the valve is closed, paint is blocked from flowing down the main line, and is, instead, diverted to a flow control device 72.

When the applicator 54 is ready to spray, paint must be loaded into the main line all the way out to the applicator 54. Based on this loading, the bypass valve can be in the open position. The ball 26 can be oriented to allow paint to flow through it. Seats can be installed against the ball, and thereby seal paint from traveling outside of the main line flow path 32.

The main paint lines 40, including the passage 32 through the ball, can be sized to allow a pig 14 to pass through them easily but with no clearance. On the paint fill cycle, paint can push a pig 14 from the pig 14 launch 56 valve, through the lines, through the ball 26 in the bypass valve, and into the pig 14 catch valve. When the pig 14 is sensed in the catch valve, the lines are full of paint. Two valves near the flow control device 72 can be opened to allow paint from the main lines to fill the passageways to and from the device. At this point, the system is ready for spraying paint with flow control.

The bypass valve can be closed based on the valve openings near the flow control device 72. The flow control device 72 can be turned on at simultaneously with the closing of the the bypass valve. The seat downstream of the ball 26 seals against the ball 26 and does not allow paint to flow anywhere except toward the applicator 54. Notches in the upstream side of the ball 26 allow paint to flow around the ball 26 into the center section of the valve body. From the center section of the valve body, paint can flow through the center hole of the ball, through a manifold and fittings, and into the flow control device 72. From the flow control device 72, paint can flow to another valve located in the main paint line 40 downstream of the bypass valve. This valve can open allowing flow-controlled paint into the main line and out to the applicator 54. The applicator 54 is now spraying with paint where the exact volume and rate of flow are known.

Based on an end of color usage, remaining color in the line can be reclaimed. The flow control device 72 can be turned off and the bypass valve can be again opened. The pig 14 that was in the pig 14 catch valve can be released with pressurized air behind it. The pig 14 can push the paint through the main line, through the bypass valve and ball, and back into the pig 14 launch 56 valve. When the pig 14 is sensed in the pig 14 launch/catch 56 valve, the paint has been reclaimed from the system.

While the paint is being reclaimed, the seats can seal against the ball 26 and block any flow to or from the center section of the valve body. At this time, cleaning of the flow control device 72 and passageways to and from it will begin. Attached to the valve body can be a manifold block 70 that can have a fluid path directed into the center section of the valve body and directly at the ball. Also attached to the manifold block 70 can be solvent and air valves 34. During reclaim, the solvent and air valves 34 can be cycled on and off to alternately provide solvent and air (solvent air chop) to the center section of the valve body, the passageways to the flow control device 72, and the flow control device 72. In this manner, these parts and passageways can be cleaned. This solvent air chop, after the flow control device 72, can be sent to another valve, where it will be dumped to a waste manifold. During this cleaning process, the outside diameter of the ball 26 will be cleaned of any paint. This can provide that there are no small areas where paint can remain and cause contamination of paint colors. This is further advantageous when the seats start to wear and leak small amounts of paint.

Based on the main line being reclaimed, separate solvent and air chop can clean these lines. This line cleaning can occur simultaneously to the flow control device 72 cleaning.

The flow control device 72 can be any assembly that can control an exact flow rate of paint. Examples include gear pumps and Ransburg MVRs (Material Valve Regulators), produced by Carlisle Fluid Technologies, Inc.

Further disclosed is a new method of providing pressure and flow control of paint supplied to an applicator 54. In addition to providing paint pressure and flow control, this system provides means to pig 14 the paint back to the main color lines, thereby saving the end user money through paint reclamation.

This disclosure enables single pump flow control with a single-color stack. Each paint applicator 54 will require only one fluid panel and 1 color stack, and each fluid panel will require only one pump for flow control. Further nothing more than a gear pump can be required for flow control. Further, pressure and flow control of paint is not mounted on robot arm inside spray booth. In some embodiments, a fluid panel is located in a more serviceable area outside of spray booth.

The embodiments disclosed herein can further be used on 2K systems, for isocyanate, polyol, and/or catalyst. The embodiments disclosed herein can be used equally for solvent borne and water borne paints. The embodiments disclosed herein enable monitoring of the entire system status, as the piggable flow control can be integrated into a plant's main programmable logic controller such that each fluid panel status can be monitored remotely. In a 2K system, a catalyst line 52 can be used.

A diverter valve 10 can include an inlet 62, a main line outlet 63; a flow control outlet 64; and a bypass member 26, wherein the bypass member 26 comprises a passage 32 extending through an axis of the bypass member 26 and a plurality of notches. In some embodiments, the diverter valve 10 can provide that the bypass member 26 is configured to be switchable between an open position that allows a flow from the inlet 62 to the main line outlet 63 and a flow control position that allows flow from the inlet 62 to the flow control outlet 64. According to certain embodiments, the diverter valve 10 can further include a plurality of member seats 58 58. According to certain embodiments, the diverter valve 10 can provide that at least one member seat is a main line seat 66 configured to receive the bypass member 26 and wherein the flow passes through the axis of the bypass member 26. In some embodiments, the diverter valve 10 can provide that the plurality of the member seats 58 comprises at least one flow control seat 68 configured receive the bypass member 26 and divert the flow to the flow control outlet 64. Flow can go through the diverter valve 10 to the flow control device 72 based on the bypass member 26 being seated in the flow control seat 68 by use of the flow notch 28. Flow can go through the diverter valve 10 to the main line 40 based on the bypass member 26 being seated in the main line seat 66 by use of the seat notch 30.

In certain embodiments, the diverter valve 10 can provide that the flow control seats 68 are configured to seal an upstream and a downstream side of the bypass member 26 and force the flow around the plurality of notches. In some embodiments, the diverter valve 10 can provide that the bypass member 26 is a ball 26 or cylinder. In some embodiments, the diverter valve 10 can include a manifold block 70, wherein the manifold block 70 has a fluid path directed to the axis of the bypass member 26.

According to some embodiments, the diverter valve 10 can be included within a system including a main line and flow control line 42, wherein the flow control line 42 includes a flow control device 72, wherein the flow control device 72 is a gear pump. In certain embodiments, the system can provide that the main line comprises at least one pig 14 launch 56 valve and at least one pig 14 catch valve. In some embodiments, the system can provide that the at least one launch 56 valve is configured to release a pig 14 and paint to the bypass member 26 through the axis to the pig 14 catch valve. In some embodiments, the system can provide that the diverter valve 10 is configured to switch to a flow control mode based on receipt of the pig 14 in the pig 14 catch valve at the robot. In some embodiments, the system can provide that the flow control device 72 is a gear pump or material valve regulator. In some embodiments, the system can provide that the main line comprises a paint applicator 54. According to some embodiments, the system can provide that main line comprises a main color header 38.

According to certain embodiments, a system can include a valve, wherein the valve in an open position is configured to allow paint and a pig 14 to flow through the valve and into a painting system, and wherein the valve in a closed position is configured for the pig 14 to be tested for wear in a pig 14 test system connected to the valve. In some embodiments, the system can be a painting system, wherein the painting system includes a flow control system. According to certain embodiments, the system can include a pig 14 test system, wherein the pig 14 test system includes a dump valve 50 on the downstream side of a pig 14 configured to release pressure above ambient pressure to atmosphere downstream of the pig.

In some embodiments, the pig 14 test system can include an air valve 34 configured to raise pressure on an upstream side of the pig. In some embodiments, the pig 14 test system can include a second dump valve 50 configured to release pressure above ambient pressure to the atmosphere on an upstream side of the pig. According to certain embodiments, the pig 14 test system can be configured to monitor pressure difference on an upstream side of the pig 14 at a beginning and end of a preset length of time. In some embodiments, the pig 14 test system can include a control unit configured to receive an indication of pig 14 quality. In certain embodiments, the indication of pig 14 quality is based on a pressure difference over a length of time being within a specified threshold.

According to certain embodiments, the system can further include a magnet 20ic pig 14 position sensor configured to communicate with the control unit, wherein the control unit is configured to receive a signal that the pig 14 and valve are in position for test. In some embodiments, the system further comprises a pig 14 replacement system. According to certain embodiments, the pig 14 replacement system can include a pig 14 replace stem 74 configured to receive a pig. In some embodiments, the pig 14 replace stem 74 can be unseated to allow for manual removal and of the pig 14 and insertion of a replacement pig.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

We claim:

1. A diverter valve comprising:
an inlet; a main line outlet; a flow control outlet; and a bypass member, wherein the bypass member comprises a passage extending through an axis of the bypass member and a plurality of notches.

2. The diverter valve of claim 1,
wherein the bypass member is configured to be switchable between an open position that allows a flow from the inlet to the main line outlet and a flow control position that allows flow from the inlet to the flow control outlet.

3. The diverter valve of claim 2,
further comprising a plurality of member seats.

4. The diverter valve of claim 3,
wherein at least one member seat is a main line seat configured to receive the bypass member and wherein the flow passes through the axis of the bypass member.

5. The diverter valve of claim 3,
wherein the plurality of the member seats comprises at least one flow control seat configured receive the bypass member and divert the flow to the flow control outlet.

6. The diverter valve of claim 5,
wherein the flow control seats is configured to seal an upstream and a downstream side of the bypass member and force the flow around the plurality of notches. 25

7. The diverter valve of claim 1,
wherein the bypass member is a ball or cylinder.

8. The diverter valve of claim 1,
further comprising a manifold block, wherein the manifold block has a fluid path directed to the axis of the bypass member.

9. A system comprising:
the diverter valve of claim 1; and a main line, wherein the main line comprises a flow control line, wherein the flow control line comprises a flow control device.

10. The system of claim 9, wherein the main line comprises at least one pig launch valve and at least one pig catch valve.

11. The system of claim 10,
wherein the at least one launch valve is configured to release a pig and paint to the bypass member through the axis to the pig catch valve.

12. The system of claim 11,
wherein the diverter valve is configured to switch to a flow control mode based on receipt of the pig in the pig catch valve at the robot.

13. The system of claim 9,
wherein the flow control device is a gear pump or material valve regulator.

14. The system of claim 9,
wherein the paint flow line comprises a paint applicator.

15. The system of claim 9,
wherein the main line comprises a main color header.
